(19) United States
(12) Patent Application Publication
(10) Pub. No.: US 2005/0188405 A1
(43) Pub. Date: Aug. 25, 2005

(54) System and method of providing integrated communications and broadcasting service

(75) Inventors: Kang Bok Lee, Daejeon-city (KR); Sang Yeoun Lee, Daejeon-city (KR); Heyung Sub Lee, Daejeon-city (KR); Kwang Soo Cho, Daejeon-city (KR); Bong Tae Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/008,321

(22) Filed: Dec. 8, 2004

(30) Foreign Application Priority Data
Feb. 21, 2004 (KR) 2004-9245

(51) Int. Cl. H04N 7/173; H04N 7/20; H04N 7/16

(52) U.S. Cl. 725/63; 725/68; 725/145; 725/115

(57) ABSTRACT

A system for and a method of providing an integrated communications and broadcasting service are provided. This system includes a transmitter and a receiver. The transmitter RF-multiplexes a CATV broadcasting signal and a satellite broadcasting signal, converts the RF-multiplexed broadcasting signal into an RF-multiplexed broadcasting optical signal having a predetermined wavelength, multiplexes the broadcasting optical signal with an Internet data signal, and transmits an integrated communications and broadcasting optical signal via a predetermined optical fiber. The receiver receives the integrated communications and broadcasting optical signal from the transmitter, demultiplexes the received signal according to a wavelength band to separate the received signal into the broadcasting optical signal and the Internet data signal, separates the broadcasting optical signal into the CATV broadcasting signal and the satellite broadcasting signal using the difference between wavelength bands of the CATV broadcasting signal and the satellite broadcasting signal, and transports the separated signals to appropriate terminals.

### BACKGROUND OF THE INVENTION

This application claims the benefit of Korean Patent Application No. 2004-9245, filed on Feb. 12, 2004, in the Korean Intellectual Property Office, the disclosure of which is incorporated herein in its entirety by reference.

1. Field of the Invention

The present invention relates to a broadcasting and communications network, and more particularly, to a system and a method of providing an integrated communications and broadcasting service through a single network.

2. Description of the Related Art

Present network infrastructures of communications and broadcasting are each divided into several types. A broadcasting network has been developed from a terrestrial network to a satellite broadcasting network via a CATV network. Depending on an application location of communications equipment, a performance of the communications equipment, and a type of communications, a communications network has been developed into various networks including wire and wireless communication networks.

At present, home subscribers receive an Internet service and a video on demand (VOD) broadcasting service from an Internet service provider (ISP) through their PCs. Also, home subscribers receive a multi-channel broadcasting using terminals, such as, TVs, either through a terrestrial network or through various media, such as, a CATV wire broadcasting network or a satellite broadcasting network.

However, a subscriber must include various systems suitable for various broadcasting services to receive the various broadcasting services. In other words, systems, such as, a cable network, a CATV settop box (STB), and the like, are necessary for CATV broadcasting. A separate satellite antenna and a satellite STB are necessary for CATV broadcasting. An Internet Protocol digital subscriber line access multiplexer (IP DSLAM) system, a modem, and separate equipment must be established to receive VOD services. Due to this reality where broadcasting services are not united, the costs for using various services are increased, which is consequently burdensome to home subscribers.

This current network structure does not meet customers' expectations that customers can receive an integrated communications and broadcasting service in a current situation where multi-media services are mainly performed. A combined network structure, where an integrated communications and broadcasting service can be implemented, is increasingly demanded and expected.

An attempt to provide communications services and broadcasting services using a single transmission line and a single receiver instead of using various transmission channels and various receivers has been made in many aspects. Examples of this attempt include a method of providing an Internet service through a CATV network and a method of connecting a digital subscriber line (xDSL) directly to a TV instead of a PC.

A method of receiving Internet and broadcasting services through a TV by combining broadcasting and communications together has been actively developed. Also, several techniques for providing through a single communications network various types of broadcasting services that require various media even though all of the services belong to broadcasting have been developed.

Examples of the developed techniques include a method of providing an integrated communications and broadcasting service using an existing CATV network, a method of providing broadcasting services by applying an optical signal overlay structure to an existing communications channel, a method of combining broadcasting services using an IP packet and a real time protocol (RTP) that provides real time services in the Internet network, and the like. In the method using the existing cable network (e.g., a hybrid fiber coaxial (HFC) network), a broadcasting network covers a data communications service, such as, an ultra-fast Internet. In the method of combining broadcasting services using the RTP, a data communications network, that is, the Internet network, covers a multi-channel broadcasting.

FIG. 1 illustrates a structure of a conventional HFC CATV network. This network is proposed in a conventional art to perform broadcasting and communications.

The CATV network of FIG. 1 is roughly comprised of a program provider 101, manufacturing and providing a broadcasting program, a system operator (SO) 102, changing channels of a program received from the program provider 101 and a program manufactured by the SO 102 to provide a broadcasting service to a subscriber 105, a CATV transmission network 103, transmitting a broadcasting signal to the SO 102, and a CATV subscriber distribution network 104, transmitting the broadcasting signal from the SO 102 to the subscriber 105.

The CATV subscriber distribution network 104 includes optical cables and coaxial cables that coexist between a distribution center 107 and the subscriber 105. Hence, the CATV subscriber distribution network 104 is called an HFC network and can provide a CATV service and an Internet service. The SO 102, which is a service provider, includes a broadcasting unit 106 and the distribution center 107. The broadcasting unit 106 transmits received contents to the subscriber 105 or transmits to the subscriber 105 received contents into which corresponding advertisements or subtitles are inserted. The distribution center 107 transmits a broadcasting signal. The CATV subscriber distribution network 104 includes optical network units (ONUs) 108, converting a received optical signal into an electrical signal. An electrical signal, into which broadcasting data is converted by the ONUs 108, is provided to the subscriber 105 through the coaxial cables. The CATV subscriber distribution network 104 may use repeaters and splitters (not sown). The number of repeaters used depends on remoteness of a subscriber, and the number of splitters used depends on the number of subscribers to be provided with services.

A major object of the use of such an HFC CATV network is to provide a CATV broadcasting service. An Internet service, a VOD service, a telephone service, and the like are also provided using a part of a bandwidth of the HFC CATV network. Thus, the use of the HFC CATV network is the most strongly recommended as a technique of providing an integrated communications and broadcasting service that is commonly used at present.

However, since a CATV network is designed based on a broadcasting network, the CATV network lacks a bandwidth for data communications to provide an Internet service. A VOD broadcasting service is not easy because of the insufficient bandwidth for data communications. At present, a cable technology standard for a new HFC network is being established to handle a VOD broadcasting service. However, the standard requires a subscriber and an SO to include new service equipment.

The CATV transmission network 103, between the program provider 101 and the SO 102, uses an asynchronous transfer mode (ATM) transport network or a dedicated line (not shown). When the ATM transport network is used, transmission efficiency is low. When the dedicated line is used, a service price is high.

FIG. 2 illustrates a structure of a satellite broadcasting network which provides a conventional satellite broadcasting.

In contrast with a terrestrial broadcasting achieved by a broadcasting station sending broadcasting electrical waves to a transmission place existing in each region and the transmission place transmitting the broadcasting electrical waves to each home, satellite broadcasting is achieved by transporting programs received from a channel provider 201 (which is called a program provider (PP)) while transmitting electrical waves corresponding to the programs to the ground via a satellite 202, for example, a sky life broadcasting center. At present, a digital satellite broadcasting is being provided in Korea and requires a separate rate and separate equipment (e.g., a satellite antenna and an STB).

However, the satellite broadcasting requires a separate network, such as, a telephone line 204, and an additional cost to provide a VOD service or an Internet service. Thus, satellite broadcasting has several disadvantages when providing an integrated communications and broadcasting service. Also, contents for satellite broadcasting are not compatible with those for CATV broadcasting.

FIG. 3 illustrates a network that covers conventional VOD and Internet broadcasting services. In an Internet network based on a router system, data for VOD broadcasting and Internet broadcasting are transmitted to an Internet user 308 using an IP multicast.

A program provider 301 capsulates MPEG data for broadcasting into an IP packet using a bandwidth pre-allocated by a backbone network 303 and transmits the IP packet through an Internet network or through a dedicated line (e.g., a synchronous optical network (SONET) or a giga Ethernet) to access routers 302, functioning as an SO. A subscriber network through which the access routers 302 transmit data to a subscriber may be a point to point network or a point to multi-point network, but must support an IP multicasting function. When the subscriber network is formed of only Ethernet, the subscriber network must provide n Internet Group Message Protocol (IGMP) Snooping function or a GARP Multicast Registration Protocol (GMRP) function.

Up to now, there is not yet proposed a specific method of economically and efficiently providing a combination of broadcasting services integrated through a single line or a single protocol with communications to home. Hence, an efficient method capable of providing all services including communications and broadcasting through a single line lead into home is demanded.

In the methods of providing an integrated communications and broadcasting service using the HFC network and using the satellite broadcasting network, a communications service is added to a broadcasting service. On the other hand, in the method of providing an integrated communications and broadcasting service using an existing IP-based Internet network, a broadcasting service is additionally achieved in a communications infrastructure. However, these three methods have difficulty in providing all services including communications and broadcasting using a single network and a single platform. In other words, a technique capable of providing a combination of an Internet service, a CATV broadcasting service, a satellite broadcasting service, VOD and Internet broadcasting, and the like through a single network has not yet been invented.

Hence, in the conventional methods, various lines are needed to provide various broadcastings through various situations and an Internet data service, and users must include dedicated devices for the various lines.

### SUMMARY OF THE INVENTION

The present invention provides a system for and a method of providing an integrated communications and broadcasting service, by which various communications services and various broadcasting services can be provided through a single platform using a network obtained by minimally changing an existing network structure.

According to an aspect of the present invention, there is provided a system providing an integrated communications and broadcasting service, the system including a transmitter and a receiver. The transmitter RF-multiplexes a CATV broadcasting signal and a satellite broadcasting signal, converts the RF-multiplexed broadcasting signal into an RF-multiplexed broadcasting optical signal having a predetermined wavelength, multiplexes the broadcasting optical signal with an Internet data signal, and transmits an integrated communications and broadcasting optical signal via a predetermined optical fiber. The receiver receives the integrated communications and broadcasting optical signal from the transmitter, demultiplexes the received signal according to a wavelength band to separate the received signal into the broadcasting optical signal and the Internet data signal, separates the broadcasting optical signal into the CATV broadcasting signal and the satellite broadcasting signal using the difference between wavelength bands of the CATV broadcasting signal and the satellite broadcasting signal, and transports the separated signals to corresponding terminals.

According to another aspect of the present invention, there is provided a method of providing an integrated communications and broadcasting service. In this method, a CATV broadcasting signal and a satellite broadcasting signal are multiplexed, and a resultant broadcasting signal of the RF-multiplexing is wavelength-multiplexed with an Internet data signal, which is a bi-directional communications optical signal for processing Internet data. A resultant optical signal of the wavelength-multiplexing is transmitted. The wavelength-multiplexed optical signal is received and demultiplexed according to a wavelength band so that the wavelength-multiplexed optical signal is separated into the RF-multiplexed broadcasting signal and the Internet data signal. The RF-multiplexed broadcasting signal is separated into the satellite broadcasting optical signals and the CATV broadcasting signal based on the fact that the satellite broadcasting optical signal and the CATV broadcasting signal have different wavelength bands. The satellite broadcasting optical signal, the CATV broadcasting signal, and the Internet data signal are transmitted to corresponding terminals.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a structure of a CATV network using a conventional hybrid fiber coaxial (HFC) network;

FIG. 2 illustrates a structure of a satellite broadcasting network which provides a conventional satellite broadcasting;

FIG. 3 illustrates a structure of a network that covers conventional VOD and Internet broadcasting services;

FIG. 4 illustrates a network that uses a system for providing an integrated communications and broadcasting service according to an embodiment of the present invention;

FIG. 5 illustrates a structure of a system for providing an integrated communications and broadcasting service, according to an embodiment of the present invention;

FIG. 6 illustrates detailed structures of a broadcasting transmission portion and a data transmission portion of a transmitter, according to an embodiment of the present invention;

FIG. 7 illustrates a detailed structure of a receiver according to an embodiment of the present invention; and

FIG. 8 is a flowchart of a method of providing an integrated communications and broadcasting service, according to an embodiment of the present invention.

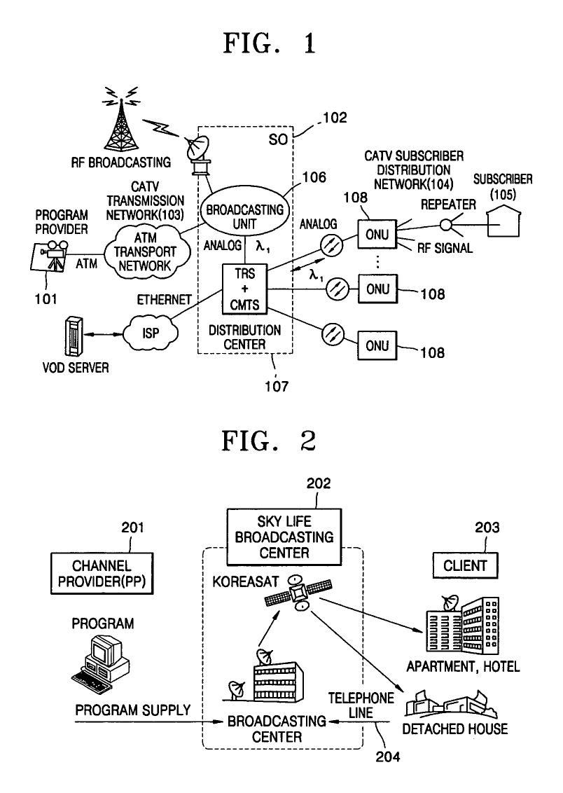

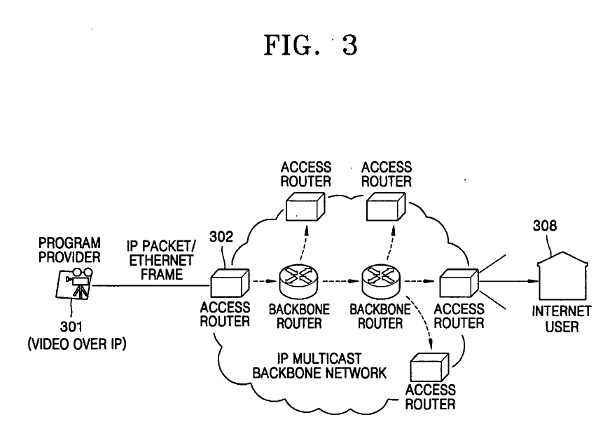

### DETAILED DESCRIPTION OF THE INVENTION

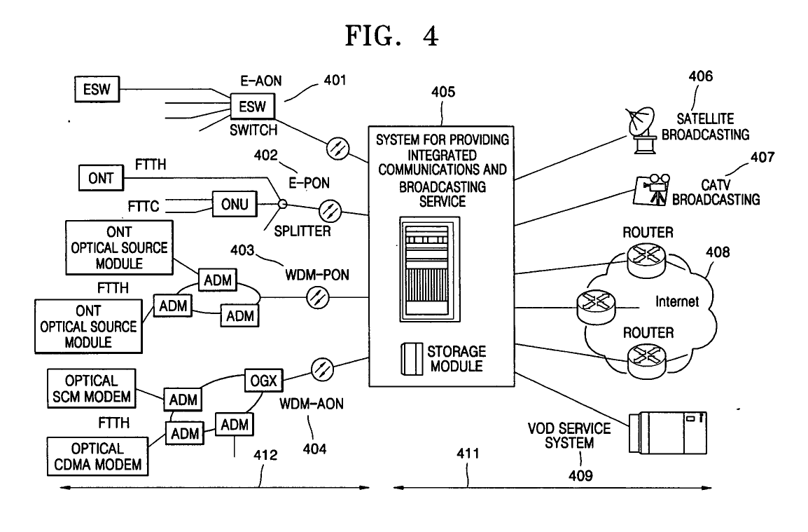

FIG. 4 illustrates an example of a network that uses a system 405 for providing an integrated communications and broadcasting service according to the present invention. This network includes the system 405, a service transport network 411, for providing broadcasting or communications programs, and an optical subscriber network 412.

The service transport network 411 includes a satellite broadcasting 406, a CATV broadcasting 407 a VOD service system 409, and an Internet network 408. The access system 405 matches the various service networks included in the service transport network 411 with one another and transmits a service signal obtained by the matching to the optical subscriber network 412, which contains actual subscribers.

The optical subscriber network 412 includes an E-active optical network (AON) 401, an E-passive optical network (PON) 402, a wavelength division multiplexing-PON (WDM-PON) 403, a WDM-AON 404, and the like according to a network structure and a method of forming a network structure. The optical subscriber network 412 may further include other types of networks that are comprised of optical cables.

The access system 405 having such a structure receives all kinds of services, such as, a satellite broadcasting, a CATV broadcasting, a VOD broadcasting, an Internet service, and the like and distributes these services to subscribers via optical cables.

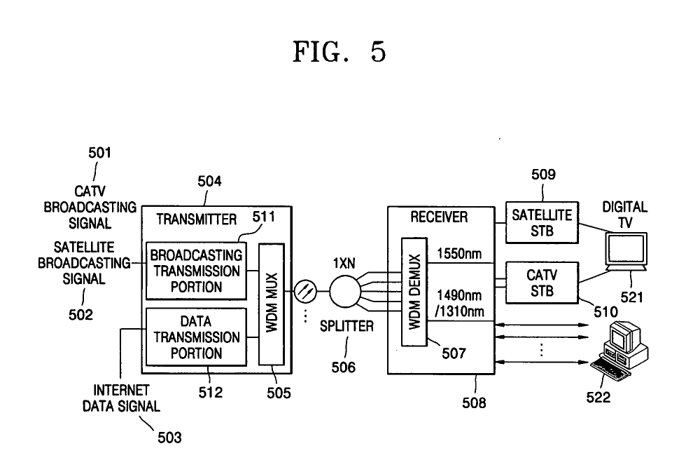

FIG. 5 illustrates a structure of a system for providing an integrated communications and broadcasting service, according to an embodiment of the present invention. FIG. 5 illustrates a structure of a system for providing an integrated communications and broadcasting service through an E-PON in the optical subscriber network 412 of FIG. 4.

The access system for providing an integrated communications and broadcasting service includes a transmitter 504 and a receiver 508. The transmitter 504 transforms a CATV broadcasting signal 501 and a satellite broadcasting signal 502 into an optical signal having a predetermined wavelength through radio frequency (RF) multiplexing and multiplexes the optical signal with an Internet data signal 503. Consequently, the transmitter 504 multiplexes optical signals having different wavelengths to transmit an integrated communications and broadcasting optical signal via an optical fiber.

The receiver 508, which is a subscriber device, receives the integrated communications and broadcasting optical signal from the transmitter 504, demultiplexes the same according to a wavelength band to separate the RF-multiplexed CATV broadcasting signal and the RF-multiplexed satellite broadcasting signal from the internet data signal 503, separates the RF-multiplexed CATV broadcasting signal from the RF-multiplexed satellite broadcasting signal, and transmits the separated signals to corresponding terminals 509, 510, 521, and 522.

Preferably, the transmitter 504 includes a broadcasting transmission portion 511 and a data transmission portion 512. The broadcasting transmission portion 511 RF-multiplexes the CATV broadcasting signal 501 and the satellite broadcasting signal 502 to output a single optical signal. The data transmission portion 512 processes the Internet data signal 503 using a predetermined method for Internet services including switching and transforms the Internet data signal 503 into an optical signal having a predetermined wavelength.

The transmitter 504 further includes a wavelength division multiplexing (WDM) MUX 505, which wavelength-multiplexes the optical signals having different wavelengths into which the satellite broadcasting signal 502, the CATV broadcasting signal 501, and the Internet data signal 503 have been converted.

An optical signal produced by the transmitter 504 is applied to a splitter 506 for increasing the number of subscribers. Hence, as many optical signals as an increased number of subscribers are output by the splitter 506 and then transmitted to the receiver 508. The receiver 508 preferably includes a WDM DEMUX 507, which demultiplexes the multiplexed optical signals received from the splitter 506 according to a wavelength band.

The transmitter 504 interfaces the CATV broadcasting signal 501, the satellite broadcasting signal 502, and the Internet data signal 503 with subscribers.

The broadcasting transmission portion 511 receives and RF-multiplexes the CATV broadcasting signal 501 and the satellite broadcasting signal 502 to transmit an optical signal. Processing of the broadcasting signals 501 and 502 corresponds to a broadcasting function. Consequently, the broadcasting transmission portion 511 performs a one-way transmission.

The data transmission portion 512 transmits and receives IP-based data, that is, serves as an interface for not only data transmitted through an Internet network but also a VOD broadcasting service.

The data transmission portion 512 performs a communications function, that is, a bi-directional optical transmission. In an E-PON illustrated in FIG. 5, bi-directional communications are performed using a single optical fiber, so data communications are performed using optical signals having two different wavelengths of 1490 nm and 1310 nm.

In the E-PON, Internet data communications are performed using 1490 nm as a wavelength of a downward optical signal of the Internet data signal 503 (i.e., an output signal of the transmitter 504) and 1310 nm as a wavelength of an upward optical signal of the Internet data signal 503 (i.e., an input signal of the transmitter 504).

A wavelength (e.g., 1550 nm) of an optical signal output by the broadcasting transmission portion 511 must be different from a wavelength of an optical signal input to/output by the data transmission portion 512. The optical signals output by the broadcasting transmission portion 511 and the data transmission portion 512 are input to the WDM MUX 505 and multiplexed thereby. A multiplexed optical signal is output as the downward optical signal to a single optical fiber. The upward optical signal is input to the data transmission portion 512. As a result, three optical signals having different wavelengths exist on the single optical fiber to provide an integrated communications and broadcasting service.

Hence, data received through a communications network and multiplexed multi-channel broadcasting signals are integrated and provided to the single optical fiber.

The splitter 506 is a passive device for extending the number of subscribers over an E-PON. For example, the number of subscribers can be extended up to 64. Although the E-PON is used as an example of a subscriber network in FIG. 5, a network through which transmission and reception are separately performed, such as, a metro-Ethernet network, may be used. Also, an optical fiber used is not necessarily the single optical fiber.

The WDD DEMUX 507 is a passive device located on a subscriber side and divides a wavelength of the optical signal into which the optical signals output by the broadcasting transmission portion 511 and the data transmission portion 512 are multiplexed by the WDM MUX 505.

The receiver 508 transforms an optical signal for broadcasting and an optical signal for data communications, into which the multiplexed optical signal is demultiplexed by the WDM DEMUX 507, into electrical signals corresponding to services and transmits the electrical signals to service platforms, such as, a satellite STB 509, a CATV STB 510, and a PC 522 within a subscriber's house. As described above, several service platforms are used to cover several services in FIG. 5, but a single platform may be used for the several services.

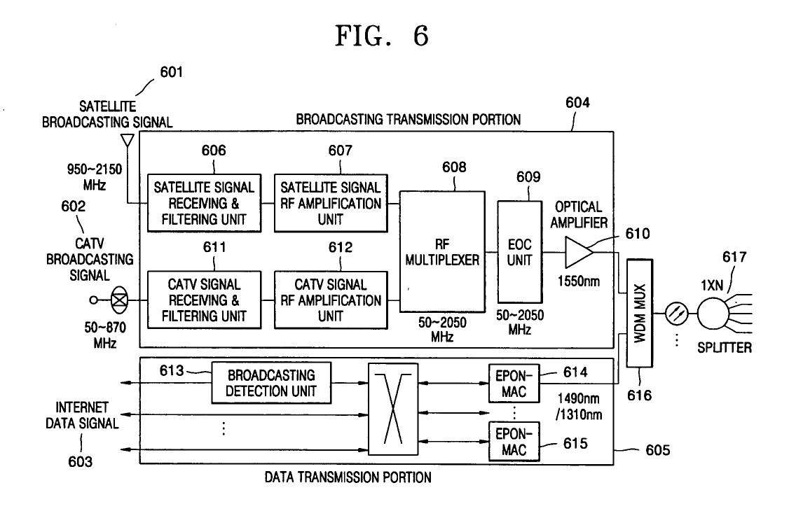

FIG. 6 illustrates detailed structures of a broadcasting transmission portion 604 and a data transmission portion 605 of a transmitter, according to an embodiment of the present invention.

The broadcasting transmission portion 604 includes a satellite signal receiving & filtering unit 606, receiving and filtering a satellite broadcasting signal 601, a satellite signal RF amplification unit 607, amplifying a satellite broadcasting signal filtered by the satellite signal receiving & filtering unit 606 according to a frequency band of the satellite broadcasting signal, a CATV signal receiving & filtering unit 611, receiving and filtering a CATV broadcasting signal 602, a CATV signal RF amplification unit 612, amplifying a CATV broadcasting signal filtered by the CATV signal receiving & filtering unit 611 according to a frequency band of the CATV broadcasting signal, an RF multiplexer 608, multiplexing the satellite broadcasting signal amplified by the satellite signal RF amplification unit 607 and the CATV broadcasting signal amplified by the CATV signal RF amplification unit 612, and an electric-to-optic conversion (EOC) unit 609, converting an RF signal produced by the RF multiplexer 608 into an optical signal having a predetermined wavelength.

The broadcasting transmission portion 604 preferably further includes an optical amplifier 610, amplifying an output of the optical signal produced by the EOC unit 609.

In this case, the satellite broadcasting signal 601 and the CATV broadcasting signal 602 preferably have a frequency band of 950 to 2150 MHz and a frequency band of 50 to 870 MHz, respectively. Consequently, the RF signal produced by the RF multiplexer 608 preferably has a frequency band of 50 to 2150 MHz.

According to current broadcasting characteristics, a satellite broadcasting and a CATV broadcasting use different frequency bands. The CATV broadcasting uses a frequency band of 50 to 870 MHz, and the satellite broadcasting passes through a low noise block (LNB) module and is then transmitted using a frequency band of 950 to 2150 MHz. Two multi-channel broadcastings, which serve satellite and CATV broadcastings having different frequency bands, are filtered by the satellite signal receiving & filtering unit 606 and the CATV signal receiving & filtering unit 611, respectively, and then amplified by the satellite signal RF amplification unit 607 and the CATV signal RF amplification unit 612, respectively.

Electrical signals corresponding to the satellite and CATV broadcastings amplified by the satellite signal RF amplification unit 607 and the CATV signal RF amplification unit 612 are multiplexed by the RF multiplexer 608 to produce the RF signal having the frequency band of 50 to 2150 MHz. The RF signal is converted into an optical signal by the EOC unit 609.

As necessary, the optical signal corresponding to a thus-integrated broadcasting signal is amplified by an optical amplifier 610, and an amplified optical signal is transmitted through a subscriber network. A wavelength of the optical signal corresponding to the integrated broadcasting signal is different from an optical line terminator (OLT) data wavelength for an Internet data signal 603. Although a wavelength of 1550 nm and a wavelength of 1490/1310 nm are used for the integrated broadcasting signal and the Internet data signal 603, respectively, in the embodiment of FIG. 6, other wavelengths may be used.

The data transmission portion 605 serves as an interface for IP-based data and performs a function such as L2/L3 switching for a conventional Internet service. The data transmission portion 605 includes a broadcasting detection unit 613, which interfaces not only data transmitted through an Internet network but also a video on demand (VOD) broadcasting service.

Like a commonly used E-PON system providing an IP/Ethernet-based service, the illustrated E-PON has a structure in which EPON media access control (MAC) mastering functions 614 and 615 are performed. Hence, the data transmission portion 605 processes an Internet data signal 613 using the same method as a method of processing data in a conventional Internet network. Alternatively, the data transmission portion 605 may use a conventional way in which an optical signal is used, to process Internet data.

As described above with reference to FIG. 5, in the E-PON of the data transmission portion 605 of FIG. 6, Internet data communications are performed using an optical signal having a 1490 nm/1310 nm wavelength in which 1490 nm and 1310 nm are used as a wavelength of a downward optical signals of the Internet data signal 603 (i.e., an output signal of the data transmission portion 605) and a wavelength of an upward optical signal of the Internet data signal 613 (i.e., an input signal of the data transmission portion 605), respectively.

Preferably, the multiplexed optical signal obtained by a WDM MUX 616 and transmitted via an optical fiber has a wavelength of 1200 to 1600 nm.

This optical signal is input to the receiver 508, which is located on a subscriber side, via a splitter 617, having one input port and N output ports.

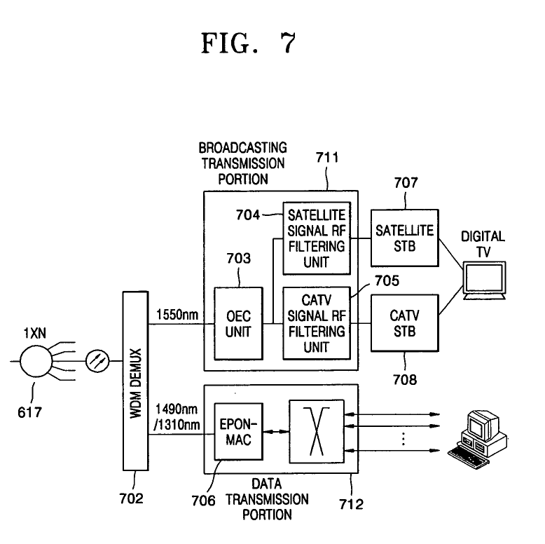

FIG. 7 illustrates a detailed structure of a receiver according to an embodiment of the present invention. The receiver includes a broadcasting receiving portion 711 and a data receiving portion 712. The broadcasting receiving portion 711 transmits a CATV broadcasting signal and a satellite broadcasting signal of signals into which the multiplexed optical signal is separated through demultiplexing according to a wavelength band, to corresponding terminals, which are a satellite STB 707 and a CATV STB 708. The data receiving portion 712 processes the remaining Internet data signal, into which the multiplexed optical signal is separated through demultiplexing according to a wavelength band, using a predetermined method for Internet services including switching and transmits the processed Internet data signal to a corresponding terminal.

The receiver includes a WDM DEMUX 702, which demultiplexes the multiplexed optical signal split by the splitter 617 according to a wavelength band.

The broadcasting receiving portion 711 includes an optic-to-electric conversion (OEC) unit 703, a satellite RF filtering unit 704, and a CATV RF filtering unit 705. The OEC unit 703 receives the optical signal, into which the satellite broadcasting optical signal and the CATV broadcasting signal have been multiplexed, separated through demultiplexing by the WDM DEMUX 702, and converts the optical signal into an electrical RF signal. The satellite RF filtering unit 704 receives the RF signal from the OEC unit 703 and extracts the satellite broadcasting signal from the RF signal. The CATV RF filtering unit 705 receives the RF signal from the OEC unit 703 and extracts the CATV broadcasting signal from the RF signal.

The OEC unit 703 converts the received optical signal having a wavelength of 1550 nm into an RF signal of 50 to 2150 MHz. The RF signal is separated into the original CATV broadcasting signal and the original satellite broadcasting signal according to a wavelength by passing though the RF filtering units 704 and 705.

The satellite signal RF filtering unit 704 filters out a satellite broadcasting channel in the range of 950 to 2150 MHz and outputs the same to a service platform such as the satellite STB 707. The CATV signal RF filtering unit 705 filters out a CATV broadcasting channel in the range of 50 to 870 MHz and outputs the same to the CATV STB 708.

The data receiving portion 712 is a functional block which receives and processes IP-based data, so performs an EPON slave MAC function 710 and an Ethernet switching function over the illustrated E-PON as in a functional block of a commonly-used E-PON ONT system for providing an IP/Ethernet-based service. Hence, the data receiving portion 712 processes data in the same way as the way of processing data in a conventional Internet network. The data receiving portion 712 may use a conventional method of processing an optical signal without change.

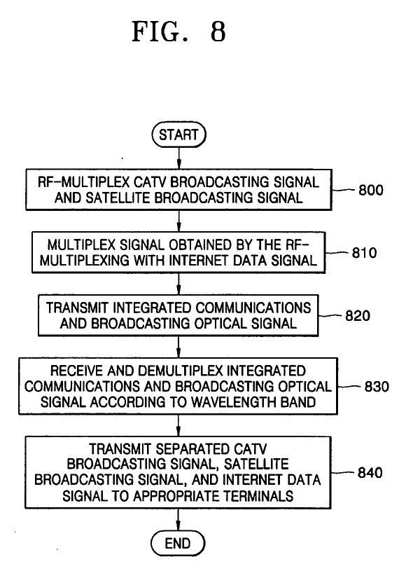

FIG. 8 is a flowchart of a method of providing a combined service of communications and broadcasting, according to an embodiment of the present invention. This method includes operations 800, 810, and 820, which are performed in a transmitter, and operations 830 and 840, which are performed in a receiver. In operation 800, the transmitter RF-multiplexes a CATV broadcasting signal and a satellite broadcasting signal to produce an RF-multiplexed broadcasting optical signal. In operation 810, the transmitter wavelength-multiplexes the RF-multiplexed broadcasting optical signal with an Internet data signal, which is a bidirectional communications optical signal for processing Internet data. In operation 820, the transmitter transmits an integrated communications and broadcasting optical signal obtained by the wavelength-multiplexing in operation 810 to the receiver.

In operation 830, the receiver receives the integrated communications and broadcasting optical signal, demultiplexes the optical signal according to a wavelength band so that the integrated optical signal is separated into the RF-multiplexed broadcasting optical signal and the Internet data signal, and separates the RF-multiplexed broadcasting optical signal into the original CATV broadcasting signal and the original satellite broadcasting signal according to a frequency band. In operation 840, the receiver transmits the CATV broadcasting signal, the satellite broadcasting signal, and the Internet data signal to corresponding terminals.

Since these operations are the same as described above with reference to FIGS. 5 through 7, detailed descriptions thereof will be omitted herein.

A system for providing an integrated communications and broadcasting service according to the present invention includes a transmitter and a receiver. The transmitter RF multiplexes a CATV broadcasting signal and a satellite broadcasting signal, converts the RF-multiplexed broadcasting signals into an optical signal having a predetermined wavelength, and multiplexes the optical signal with an Internet data signal to transmit an integrated communications and broadcasting optical signal via a predetermined optical fiber to the receiver. The receiver receives the integrated communications and broadcasting optical signal, demultiplexes the received signal according to a wavelength band to separate the received signal into the RF-multiplexed broadcasting optical signal and the Internet data signal, separates the RF-multiplexed broadcasting optical signal into the original CATV broadcasting signal and the original satellite broadcasting signal, and transports the separated signals to appropriate terminals. This system can provide an integrated broadcasting service including various types of broadcasting services through a single communications network. Hence, service providers can use an efficient network, and subscribers can receive several services through a single platform. In other words, a broadcasting service and an Internet service, such as, a CATV broadcasting, a satellite broadcasting, a multi-channel Internet broadcasting, a VOD broadcasting, and the like, can be simultaneously provided through a single wire line.

This system according to the present invention and a method of providing an integrated communications and broadcasting service using this system have the following advantages, compared with a conventional Internet network or a convention broadcasting network. First, in contrast with a conventional system in which a CATV broadcasting network, a satellite broadcasting network, and a subscriber network for Internet services separately exist to provide corresponding services to subscribers, the CATV broadcasting network, the satellite broadcasting network, and the subscriber network for Internet services are integrated to provide a multiplexed optical signal. Thus, a combination of communications and broadcasting can be simply achieved, and all services can be provided to subscribers through a single optical subscriber network.

Second, a satellite broadcasting signal and a CATV broadcasting signal can be easily multiplexed because they use different frequency bands, and a multiplexing technique required by digital broadcasting can be easily applied to the multiplexing of the broadcasting signals. Thus, the method according to the present invention can be more simply implemented than a method of providing an integrated communications and broadcasting service using conversion of an RF signal into an IP frame.

Third, in a conventional art, equipments corresponding to different services, such as, a CATV STB, a satellite antenna & a satellite STB, Internet equipment, and the like, must be separately installed. However, in the present invention, all broadcasting services and communications services can be provided through a single line, so separate equipments that a subscriber needed to receive all services can be integrated. Consequently, the number of systems within a house can be drastically reduced, thereby achieving a cost-efficient service supply.

Fourth, a satellite broadcasting signal and a CATV broadcasting signal can be easily multiplexed because they use different frequency bands, and a multiplexing technique required by digital broadcasting can be easily applied to the multiplexing of the broadcasting signals. Thus, the method according to the present invention can be more simply implemented than a method of providing an integrated communications and broadcasting service using in-band broadcasting.

Fifth, a CATV broadcasting signal and a satellite broadcasting signal are multiplexed to transmit an optical signal having a single wavelength, so the number of WDM couplers and the number of wavelengths divided by the WDM coupler for reception can be reduced. The number of extra optical amplifiers required to transmit CATV broadcasting and satellite broadcasting can also be reduced. Thus, costs of forming an integrated communications and broadcasting network are reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

Also, it can be easily recognized by one of ordinary skill in the art that operations of the method according to the present invention can be implemented in various software or hardware ways by using a general programming technique.

1. A system providing an integrated communications and broadcasting service, the system comprising:
a transmitter RF-multiplexing a CATV broadcasting signal and a satellite broadcasting signal, converting the RF-multiplexed broadcasting signal into an RF-multiplexed broadcasting optical signal having a predetermined wavelength, multiplexing the broadcasting optical signal with an Internet data signal, and transmitting an integrated communications and broadcasting optical signal via a predetermined optical fiber; and
a receiver receiving the integrated communications and broadcasting optical signal from the transmitter, demultiplexing the received signal according to a wavelength band to separate the received signal into the broadcasting optical signal and the Internet data signal, separating the broadcasting optical signal into the CATV broadcasting signal and the satellite broadcasting signal using the difference between wavelength bands of the CATV broadcasting signal and the satellite broadcasting signal, and transporting the separated signals to corresponding terminals.

2. The system of claim 1, wherein;
the transmitter comprises a broadcasting transmission portion RF-multiplexing the CATV broadcasting signal and the satellite broadcasting signal and converting the RF-multiplexed broadcasting signal into the broadcasting optical signal; and
the broadcasting transmission portion comprises:
a satellite signal receiving & filtering unit receiving and filtering the satellite broadcasting signal;
a satellite signal RF amplification unit amplifying a satellite broadcasting signal filtered by the satellite signal receiving & filtering unit according to a frequency band of the satellite broadcasting signal;
a CATV signal receiving & filtering unit receiving and filtering the CATV broadcasting signal;
a CATV signal RF amplification unit amplifying a CATV broadcasting signal filtered by the CATV signal receiving & filtering unit according to a frequency band of the CATV broadcasting signal;
an RF multiplexing unit RF-multiplexing the satellite broadcasting signal and the CATV broadcasting signal that have been amplified by the satellite signal receiving & filtering unit and the CATV signal receiving & filtering unit, respectively; and
an electric-to-optic conversion unit converting the RF-multiplexed broadcasting signal into the optical signal having a predetermined wavelength.

3. The system of claim 2, wherein the RF-multiplexed broadcasting signal produced by the RF multiplexing unit has a frequency band of 50 MHz to 2150 MHz.

4. The system of claim 2, wherein the broadcasting transmission portion further comprises an optical amplifier amplifying an output of the optical signal obtained by the electric-to-optical conversion unit.

5. The system of claim 1, wherein the transmitter further comprises a data transmission portion processing the Internet data signal using a predetermined method for Internet services including switching and converting the Internet data signal into an optical signal having a predetermined wavelength.

6. The system of claim 2, wherein the transmitter further comprises a wavelength division multiplexing unit wavelength-multiplexing the optical signal corresponding to the RF-multiplexed broadcasting signal and the optical signal corresponding to the Internet data signal.

7. The system of claim 6, wherein an optical signal produced by the wavelength division multiplexing unit and transmitted via an optical fiber has a wavelength of 1200 to 1600 nm.

8. The system of claim 1, wherein the integrated communications and broadcasting optical signal transmitted by the transmitter is received by a splitter extending a number of subscribers, and as many optical signals as the extended number of subscribers are output by the splitter and transmitted to the receiver.

9. The system of claim 1, wherein the receiver comprises a wavelength division demultiplexing unit demultiplexing the received wavelength-multiplexed optical signals according to a wavelength band.

10. The system of claim 9, wherein:
the receiver comprises a broadcasting receiving portion transmitting a CATV broadcasting signal and a satellite broadcasting signal, into which the integrated communications and broadcasting optical signal received from the transmitter is demultiplexed according to a wavelength band, to corresponding terminals; and
the broadcasting receiving portion comprises:
an optic-to-electric conversion unit receiving the RF-multiplexed broadcasting optical signal, into which the satellite broadcasting signal and the CATV broadcasting signal have been multiplexed, separated through the demultiplexing by the wavelength division demultiplexing unit, and converting the received RF-multiplexed broadcasting optical signal into an electrical RF signal;
a satellite signal RF filtering unit receiving the RF signal from the optic-to-electric conversion unit and separating a satellite broadcasting signal having a predetermined frequency band from the RF signal; and
a CATV signal RF filtering unit receiving the RF signal from the optic-to-electric conversion unit and separating a CATV broadcasting signal having a predetermined frequency band from the RF signal.

11. The system of claim 10, wherein the satellite broadcasting signal has a frequency band of 950 to 2150 MHz, and the CATV broadcasting signal has a frequency band of 50 to 870 MHz.

12. The system of claim 9, wherein the receiver comprises a data receiving portion processing an Internet data signal, into which the integrated communications and broadcasting optical signal is demultiplexed according to a wavelength band, using a predetermined method for Internet services including switching and transmitting the processed Internet data signal to a corresponding terminal.

13. A method of providing an integrated communications and broadcasting service, the method comprising:
RF-multiplexing a CATV broadcasting signal and a satellite broadcasting signal and wavelength-multiplexing a resultant broadcasting signal of the RF-multiplexing with an Internet data signal, which is a bidirectional communications optical signal for processing Internet data;
transmitting a resultant optical signal of the wavelength-multiplexing;
receiving the wavelength-multiplexed optical signal, demultiplexing the wavelength-multiplexed optical signal according to a wavelength band so that the wavelength-multiplexed optical signal is separated into the RF-multiplexed broadcasting signal and the Internet data signal, and separating the RF-multiplexed broadcasting signal into the satellite broadcasting optical signals and the CATV broadcasting signal based on the fact that the satellite broadcasting optical signal and the CATV broadcasting signal have different wavelength bands; and
transmitting the satellite broadcasting optical signal, the CATV broadcasting signal, and the Internet data signal to corresponding terminals.

14. The method of claim 13, wherein the RF-multiplexing of the CATV broadcasting signal and the satellite broadcasting signal comprises:
receiving and filtering the satellite broadcasting signal and the CATV broadcasting signal;
amplifying the satellite broadcasting signal and the CATV broadcasting signal according to a frequency band;
RF-multiplexing an amplified satellite broadcasting signal and an amplified CATV broadcasting signal; and
converting an RF-multiplexed broadcasting signal into an optical signal having a predetermined wavelength.

15. The method of claim 14, further comprising amplifying an output of the converted optical signal.

16. The method of claim 13, before the receiving and wavelegth-demultiplexing of the optical signal into which the CATV broadcasting signal, the satellite broadcasting signal, and the Internet data signal are multiplexed, further comprising splitting the integrated communications and broadcasting optical signal into as many optical signals as an increased number of subscribers to provide a service to the increased number of subscribers.

17. The method of claim 13, wherein the receiving and wavelegth-demultiplexing of the optical signal into which the CATV broadcasting signal, the satellite broadcasting signal, and the Internet data signal are multiplexed comprises:
converting the resultant optical signal of the multiplexing of the satellite broadcasting signal and the CATV broadcasting signal separated through demultiplexing into RF signals; and
separating the RF signal into the satellite broadcasting signal and the CATV broadcasting signal using the fact that the satellite broadcasting signal and the CATV broadcasting signal have different frequency bands.
